(19) United States
(12) Patent Application Publication
(10) Pub. No.: US 2026/0366829 A1
(43) Pub. Date: Nov. 19, 2026

(54) ELECTROLYTICALLY NICKEL PLATED COPPER HEAT EXCHANGER ASSEMBLY

(71) Applicant: Dana Canada Corporation, Oakville (CA)

(72) Inventors: Mohammad Mehdi JALILI, Oakville (CA); Mohammad Hadi RAZMPOOSH, Mississauga (CA); Doug VANDERWEES, Mississauga (CA)

(21) Appl. No.: 19/210,897

(22) Filed: May 16, 2025

(51) Int. Cl. F28F 21/08; C25D 7/04

(52) U.S. Cl. CPC F28F 21/089; C25D 7/04; F28F 2245/00; F28F 2275/04

(57) ABSTRACT

Systems and methods are provided for pre-braze plated heat exchangers. A method of forming a heat exchanger is described, including pretreating one or more copper pieces, electrolytically plating nickel onto the one or more copper pieces, stamping components from the one or more nickel plated copper pieces, and brazing the nickel plated components. An electronic module may be metallurgically bonded to the nickel layer deposited prior to brazing.

### TECHNICAL FIELD

The present description relates generally to systems and methods for an electrolytically nickel plated copper heat exchanger assembly.

### BACKGROUND AND SUMMARY

Heat exchangers for cooling electronics in vehicles, especially electric and hybrid vehicles, can be made of copper parts. During assembly, the copper parts may be brazed together to form a copper heat exchanger. One or more electronic modules (e.g., sensor modules, power modules, control modules, and/or the like) may be secured to the exterior surface of the copper heat exchanger. Oxidation of the copper may prevent soldering the electronic module directly onto the heat exchanger. Previously, a thermal interface material (TIM) may be interposed between the copper heat exchanger and the electronic module for increased heat transfer. Alternatively, an intermediate layer, such as an organic solderable preservative (OSP) layer, may be applied to an exterior surface of the copper heat exchanger, preventing oxidation of the copper and thereby providing a solderable surface to which the electronic module may be soldered.

However, galvanic reactions involving the copper and other metals such as aluminum may degrade the copper heat exchanger. There are also other conditions in which copper heat exchangers are degraded. To provide corrosion protection and delay coolant degradation, copper heat exchangers are often plated, for example with nickel. In conventional production methods, a coating of nickel is applied after brazing, or assembling components together, often through an electroless plating method. Electroless nickel plating uses a chemical reducing agent in solution and allows for deposition of nickel ions onto internal surfaces of copper heat exchanger shapes such as flow passages where electrolytic plating would not be adequate. Along with nickel ions, phosphorus may be deposited onto the copper in electroless nickel plating methods. Electrolytic plating, which may deposit a nickel layer that does not include phosphorus, may not be possible for an assembled heat exchanger (e.g., post-brazing) due to the geometry thereof. For example, electrolytic plating may not be able to cover interior surfaces of the heat exchanger because of the size and shape of coolant pathways therein.

There are several drawbacks to post-braze electroless nickel plating. One such disadvantage is that the electroless nickel plating process imposes design restrictions on electrolessly plated heat exchangers that demand a balance of heat exchanger effectiveness and plating quality (e.g. even and accurate thickness). For example, because electroless plating relies on solution flow to evenly deposit nickel ions on a copper surface, the geometry and size of inner flow passages may be limited (e.g., in terms of diameter, cross sectional area, and/or length) in order to maintain sufficient flow of the plating solution. Thus, while electroless plating is more effective for post-braze plating than electrolytic plating, electroless plating still restricts the effectiveness of heat exchangers. Another drawback of post-braze plating is that braze joints may be damaged in a pretreatment process preceding nickel plating which may in turn compromise the structural integrity and performance of copper heat exchangers that are post-braze nickel plated. Further, post-braze plating may lead to impurities, such as metallic particles, being present in a heat exchanger formed by post braze plating. As cleanliness (e.g., lack of impurities) of heat exchangers is a factor in proper function of heat exchangers in many applications, including thermal regulation of electronics, heat exchangers with impurities due to post-braze plating may not meet standards for adequate performance. Moreover, the presence of phosphorus in the nickel coating deposited via electroless plating may render the exterior surface of the heat exchanger formed by post-braze electroless plating unsolderable, preventing bonding of the electronic module to the heat exchanger without additional modifications such as application of a coating of a solderable material over the electrolessly plated nickel layer.

In one embodiment, the issues described above may be at least partially addressed by an assembly, comprising: a heat exchanger comprising at least one nickel diffusion region where nickel is diffused into copper; and an electronic module metallurgically bonded directly to an exterior surface of the heat exchanger. The heat exchanger may be formed by a method of pre-braze electrolytic nickel plating, for example. The method of pre-braze electrolytic nickel plating may include electrolytic nickel plating onto copper before brazing of the heat exchanger assembly occurs. By including an electrolytically plated nickel layer, the heat exchanger may be directly metallurgically bonded to the electronic module, without additional preparatory materials and/or steps, such as applying an additional coating to allow metallurgical bonding. Further, compared to an electrolessly plated nickel layer, an electrolytically plated nickel layer may display higher conductivity and lower heat resistance, leading to greater heat management ability and durability of heat exchangers electrolytically plated in nickel.

In addition, plating prior to brazing components together removes design restrictions, for example on flow passages, and allows for heat exchangers to be further optimized, so long as the plating thickness is within a certain range for demanded brazing strength and metallurgical bondability (e.g., solderability). Pre-braze plating may also increase the consistency (e.g., evenness) of plating thickness throughout a heat exchanger, compared to post-braze plating where ions are deposited on irregular surfaces such as sharp corners. Further, pre-braze plating may reduce degradation of braze joints during pretreatment and may reduce a resource demand of plating compared to post-braze plating. Moreover, pre-braze plating may reduce impurities, leading to a higher cleanliness level than achievable by post-braze plating. The differences in nickel diffusion and plating structure between pre-braze plated and post-braze plated heat exchangers can be identified by studying the material through metallurgical examination techniques. Additionally, the resource demand of manufacturing a heat exchanger through pre-braze electrolytic plating may be lower than the resource demand associated with post-braze electroless plating.

For all of the reasons given above, pre-braze electrolytic nickel plating may be an advantageous method over the current technology of post-braze electroless nickel plating for creating copper heat exchangers for cooling vehicle electronics, as well as a variety of other uses of heat exchangers. Additionally, pre-braze nickel plating onto copper may be desired in forming assemblies of nickel plated copper components for applications other than heat transfer.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a flowchart of a method for pre-braze nickel plating onto copper that may be used to form a nickel plated copper heat exchanger.

FIG. 2 shows an example embodiment of a copper blank at steps of a pre-braze nickel plating method.

FIG. 3 shows an example of a copper coil at steps of a pre-braze nickel plating method.

FIG. 4 shows a continuous production line for creating nickel plated copper heat exchangers by pre-braze nickel plating.

FIG. 5 shows a cross section of an example braze joint of a nickel plated copper heat exchanger that was plated pre-braze.

FIG. 6 shows an example of a nickel plated copper heat exchanger.

FIG. 7A shows an example metallurgical examination image of a heat exchanger formed by a post-braze nickel plating process.

FIG. 7B shows an example metallurgical examination image of a heat exchanger formed by a pre-braze nickel plating process, such as the method of FIG. 1.

FIG. 8 shows an assembly comprising a pre-braze nickel plated copper heat exchanger and an electronic module.

FIG. 9 shows a flowchart of a method for manufacturing a pre-braze nickel plated copper heat exchanger assembly such as the assembly of FIG. 8.

FIGS. 10A and 10B show graphs from metallurgical examination of a post-braze nickel plated copper heat exchanger and a pre-braze nickel plated copper heat exchanger, respectively.

FIGS. 10C and 10D show images from metallurgical examination of the post-braze nickel plated copper heat exchanger and the pre-braze nickel plated copper heat exchanger, respectively.

FIGS. 11A and 11B show graphs from metallurgical examination of assemblies respectively including a post-braze nickel plated copper heat exchanger and a pre-braze nickel plated copper heat exchanger.

FIGS. 11C and 11D show images from metallurgical examination of the assemblies respectively including the post-braze nickel plated copper heat exchanger and the pre-braze nickel plated copper heat exchanger.

### DETAILED DESCRIPTION

The following disclosure relates to electrolytically nickel plated copper heat exchangers and methods of creating such heat exchangers, or other nickel plated copper assemblies. The method may include pre-braze nickel plating onto copper. Due to the plating process being electrolytic (as opposed to electroless or other plating technique), the heat exchanger formed by the methods of the present disclosure may include surfaces that are configured to be metallurgically bonded to a metal component, such as a lead of an electronic module. For example, an assembly in accordance with the present disclosure may comprise an electrolytically nickel plated copper heat exchanger and an electronic module directly metallurgically bonded (e.g., soldered or otherwise bonded via fused metals) to the heat exchanger. In this way, an intermediate layer (e.g., organic solderable preservative (OSP) applied over copper, additional layer applied over electrolessly plated nickel, etc.) conventionally used to provide a metallurgically bondable (e.g., solderable) surface on unplated copper heat exchangers and post-braze electrolessly nickel plated heat exchangers may be eliminated, reducing resource demand and simplifying manufacturing of the assembly. In addition, compared to post-braze nickel plating onto copper, pre-braze nickel plating may reduce design restrictions, lower manufacturing resource demand, eliminate degradation of braze joints during pretreatment of a post-braze plating process, and allow for a more even thickness of plating.

As used herein, “copper” may refer to substantially pure copper and/or copper alloy material, and similarly, “nickel” may refer to substantially pure nickel metal and/or nickel alloy material. Substantially pure, as used herein, may describe materials that are pure aside from traces of one or more impurities that do not affect the properties of the material, such as the ability to metallurgically bond for metals, thermal and/or electrical conductivity, mechanical properties (e.g., strength, ductility, etc.), and/or the like. A trace amount of an impurity in a material may refer to an amount no more than 1 percent by weight (wt%) of the referenced material, as an example. A substantial amount may describe an amount more than 1 wt%. A substantially pure material may comprise at least 99 wt% of the referenced material and no more than a trace amount of impurities. As an example, a metal comprising substantially pure nickel with a trace amount of phosphorus may include 99 wt% or more nickel and 1 wt% or less phosphorus. As another example, a material comprising less than 99 wt% nickel and more than 1 wt% phosphorus may be described as including a substantial amount of phosphorus. Although, depending on the composition of the impurity and the material, the threshold whereunder an amount is considered a trace amount (rather than a substantial amount) may be different according to an amount which affects the properties of the material. For example, in some instances, 2 wt% and less may be considered a trace amount, if the impurity being present at no more than 2 wt% does not affect the properties of the material.

As used herein, a “metallurgical bond” may refer to an atomic level bond between metals and/or metal alloys. Metallurgical bonds may be formed between two metal components by soldering, welding, or the like such that metals (e.g., the metal components and/or a filler metal such as solder) melt and diffuse. The two metal components may have the same composition in some examples. In other examples, the two metal components may comprise different metal element(s), and/or different ratios of the metal elements in the case of metal alloys. Metallurgical bonds may be irreversible, in some examples, such that metallurgical bonds between components may result in a permanent joint therebetween. Therefore, at least some metallurgical bonds may not be broken without causing degradation to the metallurgically bonded components. As such, metallurgically bonded components may not be disassembled (e.g., physically separated from each other) without causing degradation to the components, in such an example. In other examples, metallurgical bonds may not be irreversible. For example, some metallurgical bonded components may be separable by heating. Metallurgical bonds may not be formed between components including a substantial amount (e.g., more than 1 wt%) of non-metal materials. In metallurgical bonds between substantially metal materials, there may be a trace amount (e.g., no more than 1 wt%) of one or more impurities (e.g., non-metal materials) in the substantially metal materials, however, there may not be impurities in large enough quantities to impede the metal diffusion that results in the metallurgical bond.

A metal surface may be described as metallurgically bondable if the surface is configured to form a metallurgical bond with another metal component without preparatory step(s) (e.g., application of a coating on top of the surface), or presence of a temporary protective layer (e.g., OSP) for preserving properties of the surface. For example, a substantially pure nickel surface (e.g., surface resulting from electrolytic nickel plating) may be metallurgically bondable. Conversely, a nickel surface additionally comprising a substantial amount of phosphorus (e.g., surface resulting from electroless nickel plating) may not be metallurgically bondable due to the phosphorus being present in greater than a trace amount. As another example, a substantially copper surface may not be metallurgically bondable (e.g., solderable or the like), as an OSP coating may be demanded to prevent oxidation of the copper which may prevent metallurgical bonds from forming with the copper.

The copper surface may, however, be configured to be brazed to another copper component. To elaborate, the copper oxidation may prevent at least some types of metallurgical bonding (e.g., soldering). However, brazing may be possible despite the copper oxidation due to brazing conditions which may mitigate the copper oxidation. For example, when brazing unplated copper components, phosphorus may be introduced in conjunction with the filler metal to act as a fluxing agent in order to break up copper oxide, and as a melting point depressant for the filler metal. Conditions of brazing, including a controlled atmosphere environment (e.g., hydrogen, nitrogen, or other gas lacking oxygen) and high temperature compared to soldering, may prevent the oxide layer from reforming and increase effectiveness of the phosphorus as a fluxing agent. Conversely, when soldering copper components, the lower temperature than brazing may reduce effectiveness of the phosphorus as a fluxing agent. When soldering nickel-plated copper components, presence of phosphorus in the nickel layer (e.g., resulting from electroless plating) may adversely affect the surface energy and flowability of the solder (e.g., filler metal used for soldering) on the nickel and phosphorus surface. Additionally, the presence of phosphorus in the nickel layer in more than a trace amount may compromise the ability of the solder to bond with the nickel layer and/or the copper beneath the nickel layer, resulting in weaker bonds.

In this way, the manner and timing in which phosphorus is introduced to an assembly comprising nickel plated copper components may affect metallurgical bondability of surfaces of the assembly. To elaborate, phosphorus being introduced during (but not prior to) brazing as part of the filler metal to act as a fluxing agent may lead to successful brazing of two or more copper components (at least one of which is nickel plated), and may result in at least one surface of the brazed assembly being metallurgically bondable (e.g., solderable). Conversely, phosphorus being introduced prior to or following brazing in an electrolessly plated nickel layer on one or more of the components may reduce the ability to solder further parts to the brazed assembly. In the methods in accordance with the present disclosure, phosphorus may not be present in more than trace amounts in components (e.g., copper components and nickel layers thereof) prior to brazing during which phosphorus may be introduced as a fluxing agent in the filler metal, as described further below.

For at least the reasons described above, heat exchangers comprising an electrolessly plated nickel layer and heat exchangers without a nickel coating (e.g., substantially pure copper heat exchanger) may not be configured to metallurgically bond directly (e.g., without modification such as application of a coating) to another metal component. In contrast, an electrolytically pre-braze nickel plated heat exchanger in accordance with the present disclosure may be configured to metallurgically bond directly (e.g., without modification) to another metal component. Therefore, the systems and methods of the present disclosure may reduce resource demand and manufacturing complexity by producing a heat exchanger configured to directly metallurgically bond to an electronic module or other metal component. In this way, steps and materials conventionally demanded to provide metallurgically bondable surfaces may be eliminated.

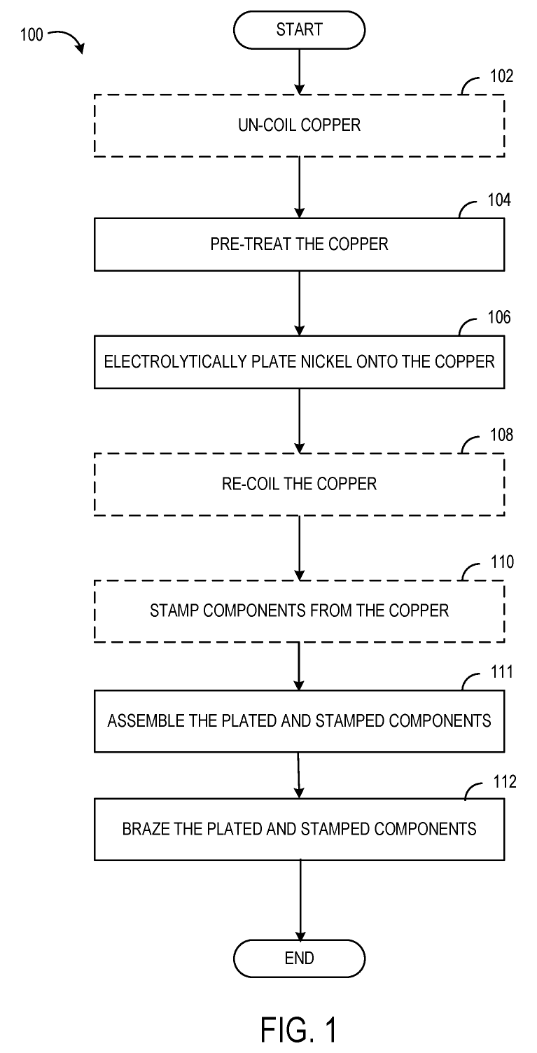

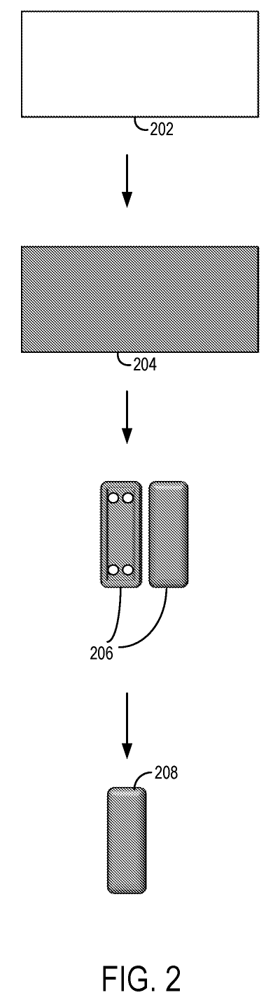

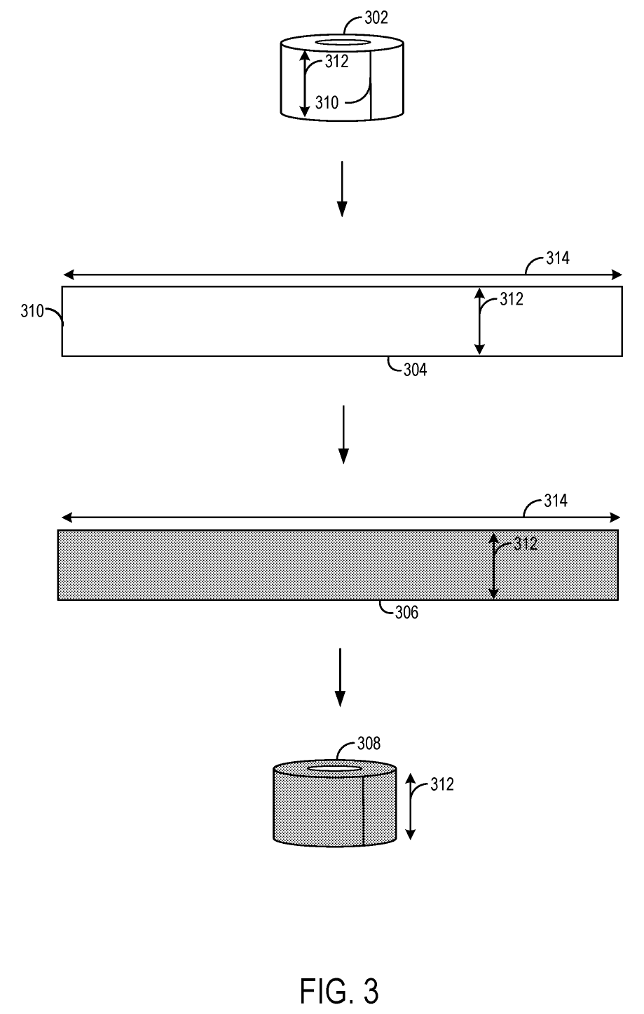

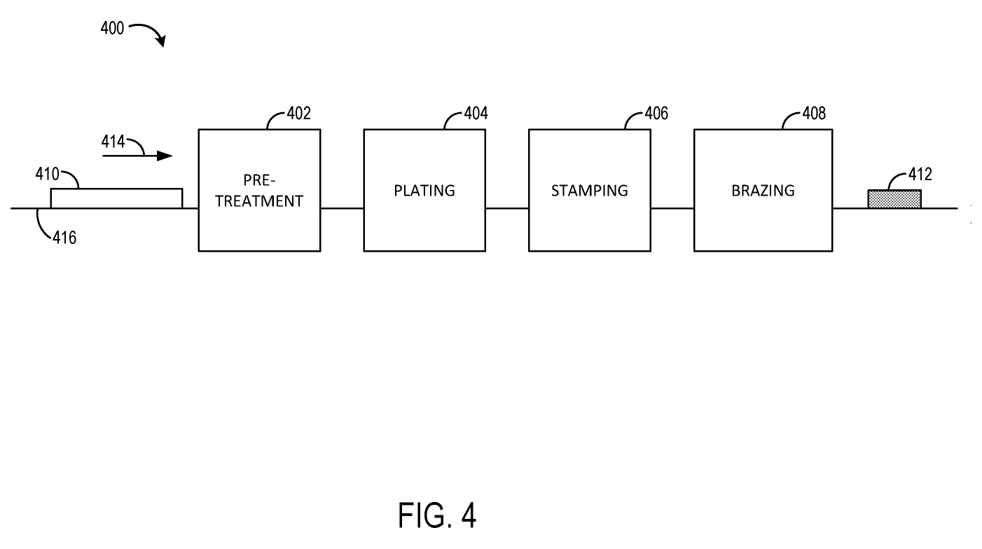

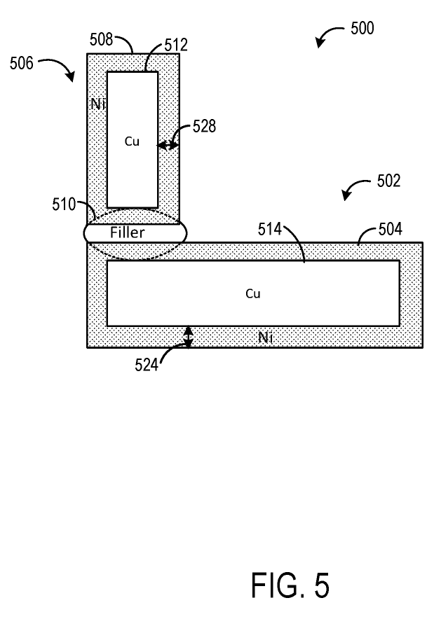

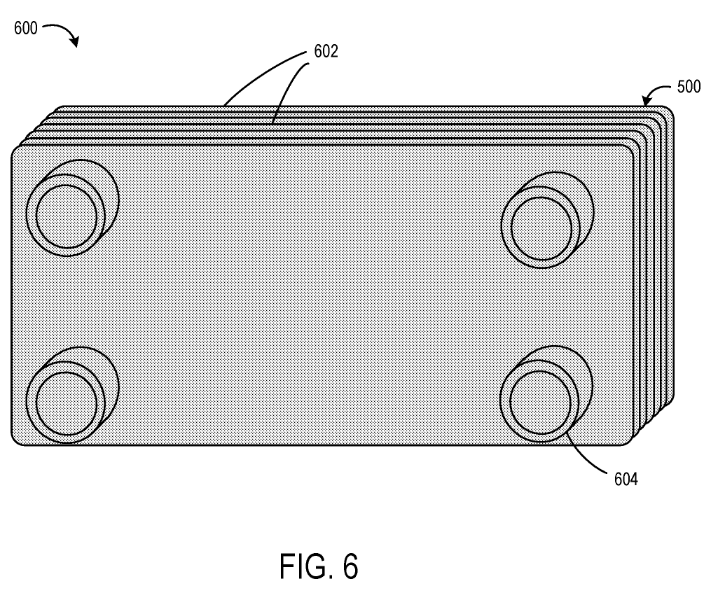

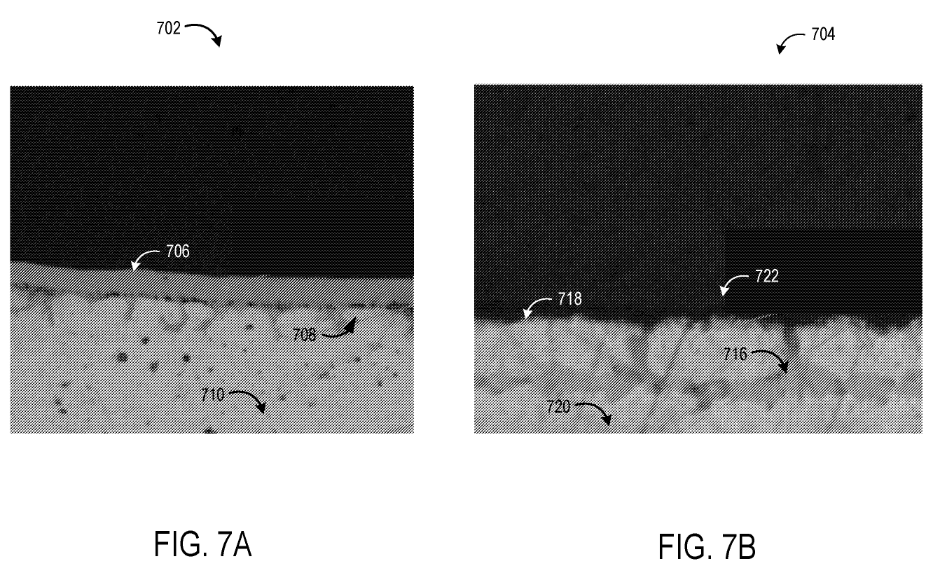

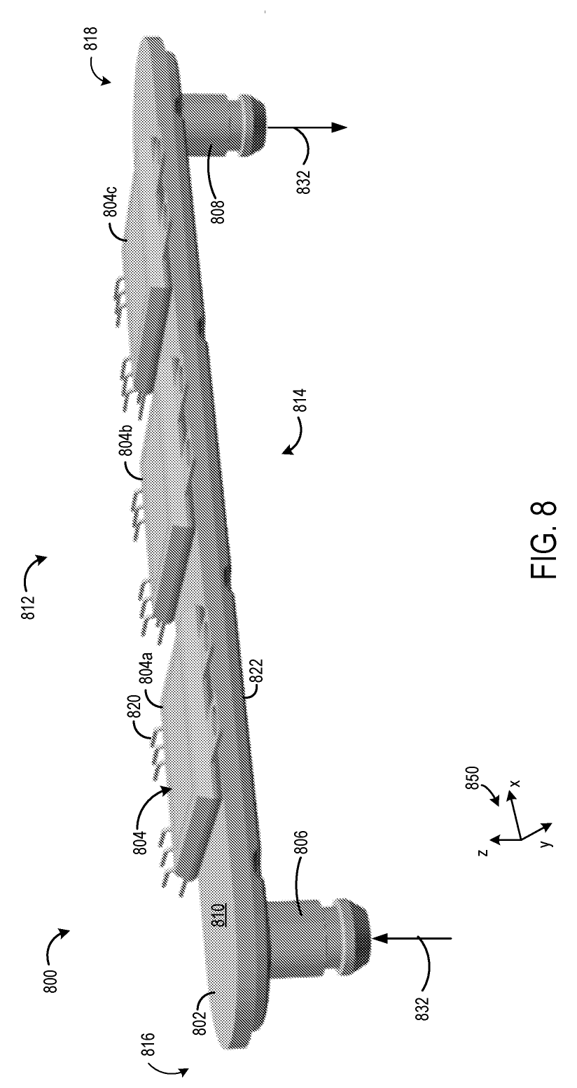

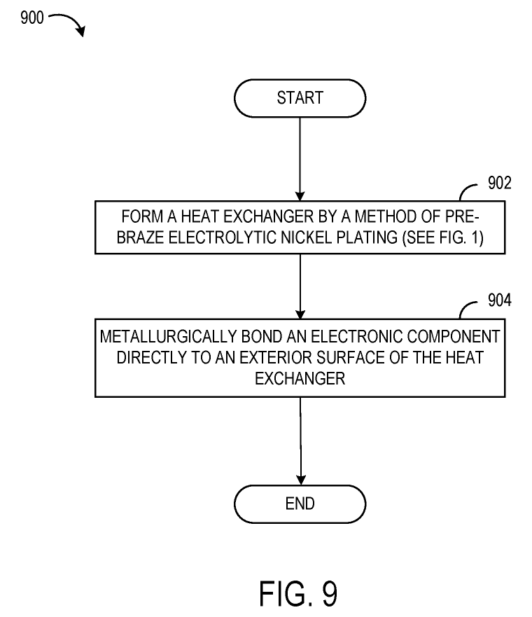

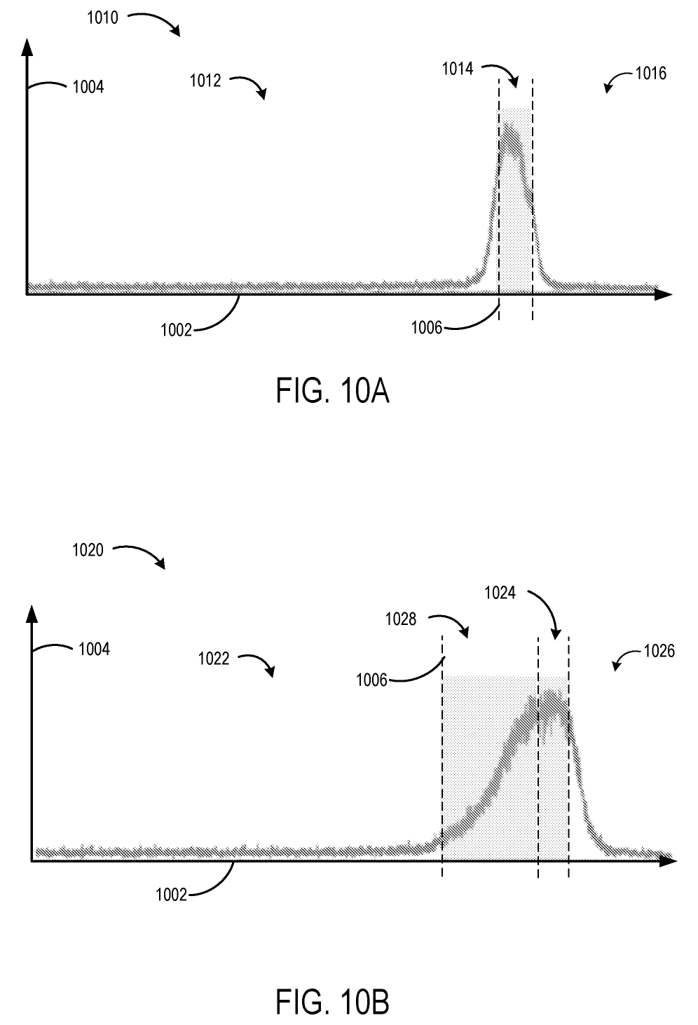

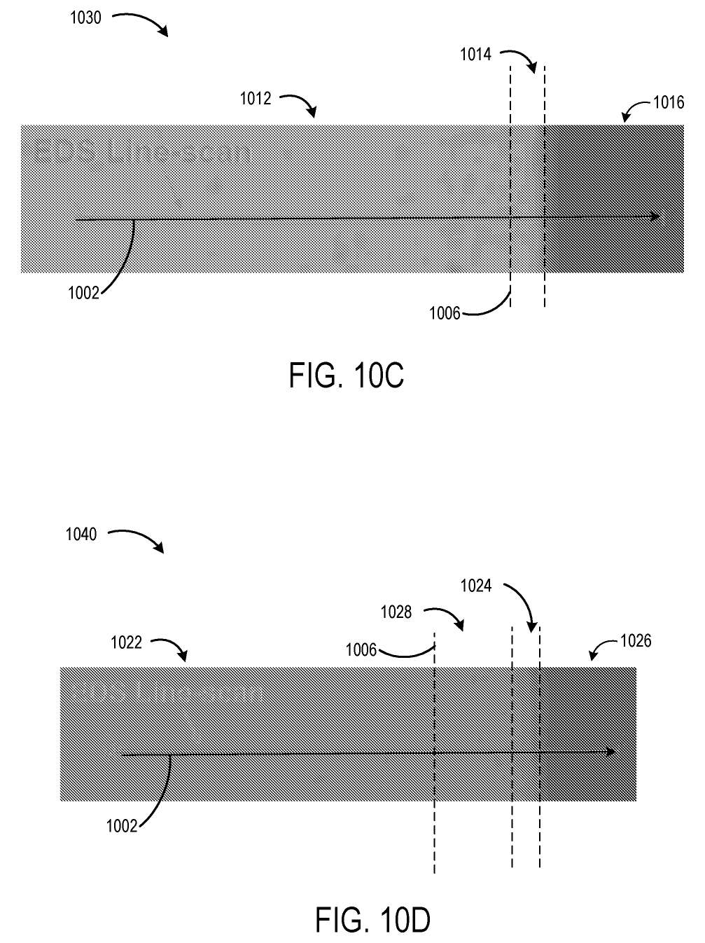

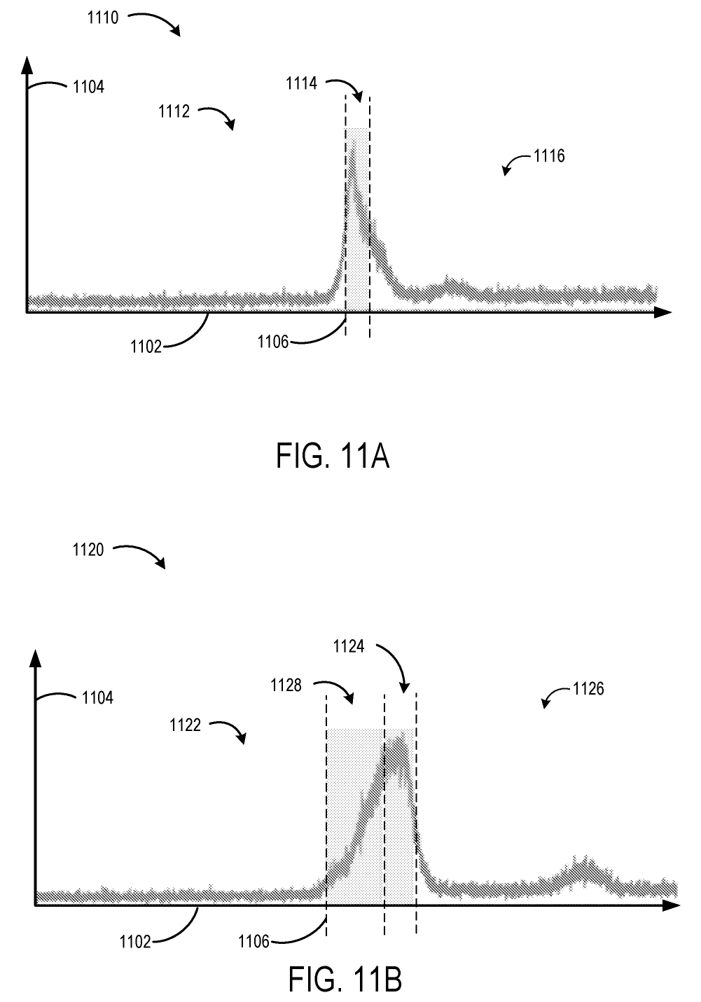

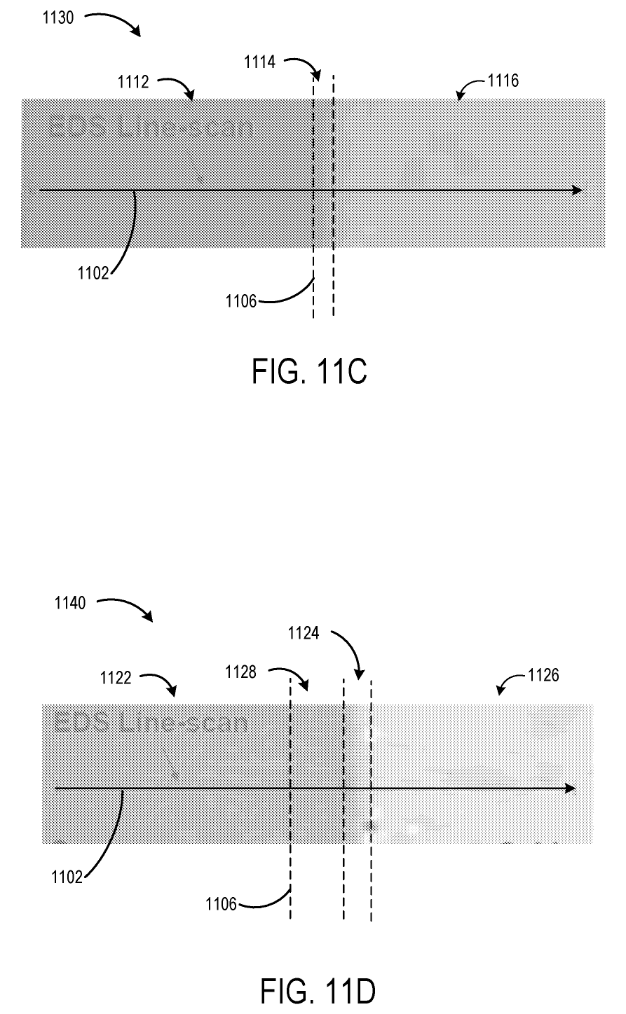

FIG. 1 shows a method of pre-braze nickel plating of unformed copper pieces (e.g., copper coil or copper blank) and/or copper components, which may form a copper heat exchanger. As indicated above, the copper pieces and/or copper components may be substantially pure copper and/or copper alloys. FIGS. 2 and 3 show examples of materials before and after steps of the method from FIG. 1, starting with a copper blank and copper coil, respectively. FIG. 4 shows an example of an assembly line wherein a continuous process implements the method of FIG. 1 to create nickel plated copper heat exchangers, more specifically, electrolytically nickel plated copper heat exchangers. FIG. 5 shows an example braze joint of a copper heat exchanger, such as a copper heat exchanger shown in FIG. 6, formed by a pre-braze plating method such as the method of FIG. 1. In FIGS. 2-6, nickel is represented by shading. FIGS. 7A and 7B show example images taken from metallurgical examination (e.g., scanning electron microscopy (SEM) analysis) of a post-braze plated heat exchanger and a pre-braze plated heat exchanger, respectively, for comparison of resulting structures. FIG. 8 shows an assembly comprising an electrolytically nickel plated heat exchanger (e.g., formed by the method of FIG. 1) metallurgically bonded to electronic modules. FIG. 9 shows a flowchart of a method for manufacturing the assembly of FIG. 8. FIGS. 10A, 10B, 11A, and 11B show graphs resulting from energy-dispersive x-ray spectroscopy (EDS) of the heat exchanger of FIG. 6 and the assembly of FIG. 8 compared to a heat exchanger formed by post-braze electroless plating and an assembly comprising the heat exchanger formed by post-braze electroless plating. FIGS. 10C, 10D, 11C, and 11D show images of cross sections corresponding to the graphs.

Now referencing FIG. 1, a method 100 is shown for pre-braze nickel plating onto copper. For example, method 100 may be used to form a nickel plated copper heat exchanger in accordance with the present disclosure. In other examples, an assembly may be formed by method 100 from pre-braze nickel plated copper components for other applications than heat transfer. A starting copper piece for method 100 may be an unformed copper piece. For example, the starting unformed copper piece for method 100 may be in the form of a copper coil such as copper coil 302 of FIG. 3. A copper coil suitable for method 100 may be a flat rectangular shaped material (e.g., uncoiled copper coil 304 of FIG. 3) rolled into a coil with cylindrical shape, such that a short end (e.g., end 310) may be accessible on an outside of the coil. The copper coil may include a variety of dimensions, such as lengths (e.g., length 314 of uncoiled copper coil 304 in FIG. 3), widths (e.g., width 312 of copper coil 302 in FIG. 3), thicknesses, and combinations thereof. Additionally or alternatively, the starting unformed copper piece for method 100 may be in the form of a copper blank (e.g., a rectangular prism) such as copper blank 202 of FIG. 2. Similar to copper coils, copper blanks may be of a variety of dimensions depending on sizes of desired heat exchanger assemblies and available equipment. Additionally or alternatively, the starting copper material may be pre-stamped, rather than unformed copper, such that the copper is in a shape of one or more heat exchanger components prior to starting method 100. Determining starting copper forms may take into account several factors, including a desired shape and size of the heat exchanger, as well as efficiency and cost of manufacturing processes. For example, when forming a copper heat exchanger with components including several plates of a certain thickness, a copper blank of a same or similar thickness may be chosen to start method 100. Pre-stamped components may also be chosen in this example, however, the process may be less efficient than starting with a blank, depending on the shapes of the pre-stamped components.

Formation of a nickel plated copper heat exchanger with method 100 may be completed by a continuous assembly line such as assembly line 400 of FIG. 4. In some embodiments, the copper starting piece 410 may take any of the forms described above and may travel along path 416 in a direction designated by arrow 414 to each of a pretreatment unit 402, an electrolytic plating unit 404, a stamping unit 406, and a brazing unit 408, resulting in a nickel plated copper heat exchanger 412. The nickel plated copper heat exchanger 412 may take several forms, according to the starting materials and resulting stamped components. For example, the nickel plated copper heat exchanger 412 may be a brazed plate heat exchanger (e.g., brazed plate heat exchanger 600 of FIG. 6) made of a plurality of nickel plated copper plates, among other components. The assembly line 400 may be an automated process, a series of manually completed steps, or a mixture thereof. Having an assembly line may streamline the production of heat exchangers and contribute to higher efficiency. Alternatively, nickel plated copper heat exchangers may be formed individually through method 100, rather than in a continuous process such as assembly line 400 in FIG. 4.

Returning to FIG. 1, at 102, method 100 optionally includes uncoiling a copper coil. Because the starting copper piece may be a coil and/or a blank and/or a heat exchanger component, this step may occur when a coil is to be plated. In other words, if the starting copper piece is not a coil, such as a blank and/or pre-stamped components, 102 may not be completed. Uncoiling a copper coil may result in an uncoiled copper coil such as a long, flat, rectangular copper piece (e.g. uncoiled copper coil 304 of FIG. 3). Uncoiling the copper coil may be achieved by means of an automated and/or manual process as part of a continuous assembly line, such as before or part of the pretreatment unit 402 in assembly line 400 of FIG. 4. Though shown in FIG. 3 as coiled and uncoiled being distinct states, material from the same coil may be in different states (e.g., coiled and uncoiled) as process of the method 100 unfolds. For example, at a time during operation of the assembly line, a first portion of material of the coil proximate to a first end thereof may be in the original coil shape and unplated, while a second portion of the material of the coil in a midsection thereof may be uncoiled and in the process of going through subsequent units of the assembly line, and a third portion of the material of the coil proximate to a second end thereof opposite of the first end across the midsection may be recoiled due to already having been plated via the subsequent units of the assembly line. In some examples, the copper coil may be rotated into different orientations than shown in FIG. 3 before being uncoiled. An uncoiled copper material may be more suitable for electrolytic nickel plating than a coil due to exposure of copper surface in the uncoiled form.

At 104, method 100 includes pretreating the copper to ensure adequate quality of the plating. The raw starting copper material may contain impurities such as dirt, oil, grease, oxides, and other extraneous materials which can impede proper plating. Therefore, pretreatment is completed at 104 to remove such materials from the copper surface in order to achieve adequate quality in terms of adhesion and durability of the nickel plating. Pretreatment may include cleaning of the unformed copper starting piece (e.g. copper blank 202 of FIG. 2 and/or copper coil 302 of FIG. 3) with a series of chemical cleaning agents and physical methods (e.g., abrasion and ultrasonic agitation). Cleaning agents used in the pretreatment process may include acid cleaners and chemicals which are surface-active with copper. Other appropriate pretreatment methods may also be used to remove impurities and prepare copper for plating. Pretreatment may occur at a pretreatment unit of a continuous assembly line, such as the pretreatment unit 402 of assembly line 400, shown in FIG. 4.

Following 104, method 100 proceeds to 106. At 106, method 100 includes electrolytically plating the pretreated copper. Electrolytic plating may involve putting the pretreated copper material (e.g., copper blank 202 of FIG. 2, uncoiled copper coil 304 of FIG. 3, or a pretreated pre-stamped copper component) and a piece of nickel or nickel alloy into a plating electrolyte solution, and applying continuous electricity such that the copper behaves as a cathode and the nickel behaves as an anode. Thus, nickel ions may be deposited onto the copper such that nickel ions are evenly disposed in a nickel coating of a thickness on surfaces of the copper. The thickness of the nickel coating may be within a range for successful brazing of the copper heat exchanger in later steps, as well as pressure durability, corrosion resistance, and metallurgical bondability. The thickness range may be between 0.1 µm and 10 µm for metallurgical bondability. However, the selected thickness range may be narrower considering corrosion resistance and brazability, for example. To elaborate, a lower bound of the thickness range may prevent a nickel plating coating that is too thin which may reduce corrosion protection. An upper bound of the thickness range may ensure that a brazing filler metal may diffuse through the nickel coating for strong braze joints, as discussed further below. For example, the lower bound of the thickness range may be 0.5 µm and the upper bound of the thickness range may be 5 µm. In other words, the thickness of nickel coating may be greater than or equal to 0.5 µm for sufficient corrosion protection and/or less than or equal to 5 µm to achieve adequately strong braze joints. In another example, the thickness range may be between 1 and 4 µm, 2 and 3 µm, and/or 1.5 and 2.5 µm to increase corrosion protection for applications with greater exposure to degrading elements (e.g., aluminum with common coolant fluid acting as an electrolyte) and/or higher rate of degradation (e.g., due to changes in pH and/or temperature of coolant fluid acting as an electrolyte), and allow for a desired tolerance in precision of filler diffusion distances. In some examples, the thickness range may be between 0.5 µm and 2 µm, with braze joint strength being greatest in this range. An amount of nickel put in the plating electrolyte solution may be determined (e.g., calculated, estimated) according to scale of equipment and/or size metrics of the copper heat exchanger design, including mass and surface area. The nickel may be substantially pure nickel. Alternatively, a nickel alloy may be used. The nickel coating resulting from plating at 106 may not include more than a trace amount of phosphorus. The plating electrolyte solution may contain nickel sulphate, and/or another suitable nickel compound. Electrolytic plating may include one or more types of electroplating (e.g., barrel, rack, continuous, line, and the like) and may be part of a continuous assembly line such as electrolytic plating unit 404 of assembly line 400 in FIG. 4. There may be one or more electrolytic plating units (e.g., electrolytic plating unit 404 of FIG. 4). For example, there may be an electrolytic plating unit for each type of copper starting material (e.g., blank, coil). One or more pretreated copper materials may be plated simultaneously in a same plating electrolyte solution with electricity applied to each piece of pretreated copper. Additionally or alternatively, there may be several separate containers of plating electrolyte solution wherein copper may be plated. The result of electrolytic plating at 106 may be a nickel plated copper piece (e.g., a nickel or nickel alloy plated copper or copper alloy piece) resembling nickel plated copper blank 204 of FIG. 2 and/or uncoiled, nickel plated copper coil 306 of FIG. 3, wherein shading indicates a nickel coating. Although method 100 describes electrolytically plating copper with nickel, other plating methods have also been considered. For example, electroless plating may be included in a pre-braze plating method such as method 100, although electroless plating may have a greater resource demand and/or may be less effective than electrolytic plating in a pre-braze plating method. Further, electroless plating may result in the nickel layer comprising a substantial amount of phosphorus or another material that prevents metallurgical bonds from forming with the nickel layer, whereas electrolytic plating may form a nickel layer that is metallurgically bondable, in part due to including no more than a trace amount of phosphorus.

After electrolytically plating, method 100 proceeds to 108 wherein the nickel or nickel alloy plated copper or copper alloy piece is optionally re-coiled to form a re-coiled, nickel plated copper coil if the starting un-plated copper piece was a copper coil (e.g. copper coil 302 of FIG. 3) and 102 was completed. In other words, if the starting un-plated copper piece was a blank, pre-stamped component, or other shape besides a coil, 108 may not be completed. For example, uncoiled copper coil 304 of FIG. 3 may be electrolytically plated to form uncoiled, nickel plated copper coil 306 of FIG. 3, and uncoiled, nickel plated copper coil 306 may be re-coiled. The resulting nickel plated coil after re-coiling at 108 may resemble re-coiled, nickel plated copper coil 308 of FIG. 3 where a re-coiled shape may be the same as a shape of the copper coil 302. Alternatively, the re-coiled shape may differ from the starting copper coil shape in at least one of number of rotations, length, width, diameter, and/or other coil dimensions as described with reference to FIG. 3 above. Re-coiling may be advantageous for transport of the nickel plated copper. In some examples, re-coiling a copper coil at 108, may prepare the copper for shaping into components (e.g., stamping) in following steps. In other examples, re-coiling may not occur if the starting un-plated copper piece was a copper coil, depending on whether a configuration of a stamping unit, such as stamping unit 406 of FIG. 4, may receive a coiled or uncoiled copper coil.

At 110, components are optionally stamped from the plated copper. If the starting copper material included pre-stamped copper heat exchanger component(s), method 100 may not include 110. However, if the starting copper material was a shape other than that of heat exchanger components (e.g., a coil and/or a blank), stamping may form a shape of heat exchanger components (e.g., stamped, nickel plated copper plates 206 of FIG. 2) from the unformed nickel plated copper (e.g. nickel plated copper blank 204 of FIG. 2 or re-coiled, nickel plated copper coil 308 of FIG. 3). Heat exchanger components formed from stamping nickel or nickel alloy plated copper or copper alloy pieces may include coreplates, baseplates, heat transfer enhancement components such as fins and turbs, and the like. Stamping may include one or more steps to achieve a desired heat exchanger component shape and may involve one or more types of stamping, such as blanking, punching, piercing, bending, and the like. Stamping may be completed by a stamping unit of a continuous assembly line, such as stamping unit 406 of assembly line 400 shown in FIG. 4. There may be a single stamping unit as shown, or there may be several stamping units in series and/or parallel. For example, there may be a stamping unit for each heat exchanger component shape.

Method 100 proceeds to 111. At 111, stamped components, including pre-stamped components and/or components stamped at 110, are assembled. Assembling may include positioning and aligning components and/or fittings and/or filler metal pieces to their relative positions in a heat exchanger design. For example, filler metal shims may be placed between components where braze joints are to be formed. Assembling may not include attaching (e.g., bonding) components together directly. For example, the components may be separably assembled such that the components may be separated without degradation. As such, the components and shims may be held by a fixture until after brazing bonds the components together. Assembling may take place as part of an assembly line such as after stamping unit 406 in assembly line 400 shown in FIG. 4. Alternatively, assembling may be part of a brazing unit such as brazing unit 408 in assembly line 400 of FIG. 4.

At 112, method 100 includes brazing the components. For example, briefly referring to FIG. 2, one or more stamped, nickel plated copper plates 206 may be layered with one or more other stamped, nickel plated copper components to form a brazed plate heat exchanger 208. Other embodiments of method 100 may include other types of components being brazed at 112, resulting in a desired heat exchanger assembly. For example, a nickel plated copper component may be brazed with an unplated copper component. Brazing may include applying high temperature by torch, furnace, induction, or other suitable methods of heating to nickel plated stamped components, and applying a filler metal to a desired joint area of heated components (e.g., stamped, nickel plated components). The filler metal may also be in the form of shims, wires, and/or pastes placed between components during and/or prior to heating. For example, shims may be placed between components during assembly at 111. The filler metal may be a metal or metal alloy with a lower melting point than that of copper and nickel, such as copper-phosphorus alloy, copper-phosphorus-silver alloy, and the like. Prior to applying the filler metal during brazing, phosphorus may not be present in the components in more than trace amounts. The high temperature may be less than a melting point of copper, and higher than a melting point of the filler metal. The filler metal may be positioned between the heated components such that the filler may cover and diffuse into at least one nickel or nickel alloy coating to form a strong braze joint. The filler metal may also form an alloy with the nickel coatings in areas where filler is diffused into nickel coatings. For example, a copper alloy filler metal may form a copper-nickel alloy in a nickel coating. The formation of an alloy during brazing may be another distinguishing feature from post-braze plating identifiable through metallurgical examination, which is discussed further below in regard to FIGS. 7A and 7B. Brazing may be completed as an automated and/or manual process in an assembly line, such as in the brazing unit 408 of assembly line 400 in FIG. 4. After brazing at 112, a nickel plated copper heat exchanger (e.g., nickel plated copper heat exchanger 412 of FIG. 4) has been assembled from brazed, stamped, nickel plated components through method 100. Thus, method 100 ends. In at least some embodiments of method 100, brazing occurs only after plating. In other words, brazing may not occur before plating. In some embodiments, method 100 may include additional steps not shown, prior to 102 and/or following 112. If included, the additional steps prior to 102 may not include metallurgical bonding or brazing.

One embodiment of a nickel plated copper heat exchanger resulting from method 100 may be a brazed plate heat exchanger 600, shown in FIG. 6. Brazed plate heat exchanger 600 comprises a plurality of components brazed together, including a plurality of plates 602 and inlet/outlet tubes 604. Braze joints, such as braze joint 500 of brazed plate heat exchanger 600, may exist at points of connection between two or more components in a nickel plated copper heat exchanger formed by a pre-braze nickel plating method, such as method 100 of FIG. 1. Braze joints in accordance with the present disclosure may be formed between two or more components, at least one of which is pre-braze electrolytic nickel plated. For example, two nickel plated components may be brazed together after plating both components. As another example, a nickel plated component and an unplated component may be brazed together after plating the nickel plated component. Therefore, at least some of the plurality of components brazed together to form the brazed plate heat exchanger 600, or other nickel plated assemblies in accordance with the present disclosure, may be nickel plated prior to brazing. However, in some examples, some of the plurality of components may not be plated. For example, inlet/outlet tubes 604 may not be plated, but may be brazed to one of the plurality of plates 602 which may be nickel plated. In such an example, the braze joint between the plate 602 and the inlet/outlet tubes 604 may include a combination of plated an unplated components. Nickel plated copper heat exchangers formed by a pre-braze nickel plating method, such as method 100 of FIG. 1, may take a variety of forms, including a brazed plate heat exchanger, such as brazed plate heat exchanger 600, a shell and tube heat exchanger, and the like.

FIG. 5 shows an example of a braze joint 500 formed between two pre-braze plated and stamped components: first copper component 502 with first nickel coating 504 and second copper component 506 with second nickel coating 508. The coatings 504 and 508 may be in face sharing contact with copper components 502 and 506, respectively. The coatings 504 and 508 may cover an outer surface of copper components 502 and 506, respectively, and conform to the shapes of copper components 502 and 506, such that an even nickel coating is achieved on each component. A thickness 524 of first nickel coating 504 may be substantially the same over the surface of the first copper component 502. Similarly, a thickness 528 of second nickel coating 508 may be substantially the same over the surface of the second copper component, such that an even nickel coating is achieved. In some examples, thicknesses 524 and 528 of first nickel coating 504 and second nickel coating 508, respectively, may be within a range of 0.5 µm to 5 µm. Additionally or alternatively, the thicknesses 524 and 528 of first nickel coating 504 and second nickel coating 508, respectively, may be within a range of 0.1 µm to 10 µm. In some examples, the thickness 524 of first nickel coating 504 may be the same as the thickness 528 of second nickel coating 508. In another example, the thickness 524 of first nickel coating 504 may not be the same as the thickness 528 of second nickel coating 508.

A filler 510 diffuses into at least one nickel coating. In this example, the filler 510 diffuses into both of the nickel coatings, including first nickel coating 504 of first copper component 502 and second nickel coating 508 of second copper component 506. The filler 510 may be copper-phosphorus or copper-phosphorus-silver alloy, or another appropriate filler metal. The filler 510 may diffuse through the full thickness of one or more nickel coatings (e.g. thickness 524 of first nickel coating 504 and thickness 528 of second nickel coating 508) at one or more points such that filler may reach copper cores (e.g. first copper core 512 and second copper core 514). Additionally or alternatively, the filler 510 may diffuse partially though the thickness (e.g., thickness 524 and thickness 528) of the nickel coatings such that solid nickel exists between filler and copper within a component. In areas where filler 510 is diffused into first nickel coating 504 and second nickel coating 508, an alloy may be formed between the nickel and filler materials. For example, a copper-nickel alloy may be formed by a copper alloy filler diffusing into a nickel layer.

While shown as the braze joint 500 joining two components, it will be understood that two or more components may be bonded at a braze joint in accordance with the present disclosure. Further, as described above, at least one of the two or more components is pre-braze nickel plated. Therefore, the filler used in brazing may diffuse into at least one nickel coating. It may be that only one of the components is nickel plated, and the other one or more components brazed to the nickel plated component are not plated. The components may be oriented in different ways relative to one another than as shown in braze joint 500 with similar diffusion of the filler into corresponding nickel coatings. Brazed, stamped, nickel plated components may also be of different shapes than first copper component 502 and second copper component 506. Additionally, other relative proportions of copper, nickel, and filler metals than those shown in FIG. 5 may be used.

FIGS. 7A and 7B show example images 702, 704 from metallurgical examination of a post-braze nickel plated copper heat exchanger and a pre-braze nickel plated copper heat exchanger, respectively. Specifically, images 702, 704 show cross sectional views which may be compared to show differences in nickel plated copper heat exchangers formed from a post-braze plating method and a pre-braze plating method. For example, images similar to images 702, 704 may be taken by scanning electron microscopy (SEM) including X-ray dispersive energy spectroscopy (EDS), and the like in order to analyze surfaces of nickel plated copper heat exchangers and determine whether the nickel plated copper heat exchangers were plated with nickel pre-braze (e.g., through method 100 of FIG. 1) or post-braze. Image 702 shows a copper component 710 of a post-braze nickel plated copper heat exchanger with a nickel coating 706, and a filler 708, wherein the filler 708 may be used in brazing to bond two or more copper components (e.g., copper component 710). Image 704 shows a copper component 720 of a pre-braze nickel plated copper heat exchanger with a nickel coating 716 and filler 718, wherein the filler 718 may be used in brazing to bond the nickel plated copper component (e.g., copper component 720 with nickel coating 716) with another component which may be a plated (e.g., nickel plated) or unplated (e.g., substantially pure) copper component. In both images, the fillers 708, 718 may be a copper alloy.

Pre-braze and post-braze nickel plated copper heat exchangers may be distinguishable by positioning of nickel and filler layers. For example, in the post-braze nickel plated copper heat exchanger of image 702 in FIG. 7A, the filler metal is in face-sharing contact with the copper component 710, and the nickel layer 706 is in face sharing contact with filler 708. Additionally, the nickel coating 706 and copper component 710 are separated, at least in part, by the filler 708. In contrast, the pre-braze nickel plated copper heat exchanger of image 704 in FIG. 7B shows the nickel coating 716 in face-sharing contact with the copper component 720. Therefore, positioning of filler metal layers and nickel coatings relative to copper components of a heat exchanger being analyzed may indicate the type of method (e.g., pre-braze or post-braze plating) used to form the heat exchanger.

Additionally, an identifiable element of pre-braze plating is alloy formation between the filler and nickel coating in a pre-braze nickel plated copper heat exchanger, such as the pre-braze nickel plated copper heat exchanger of image 704. To elaborate, during brazing (e.g., brazing at 112 of method 100 in FIG. 1), high temperatures may lead to diffusional movement of copper and nickel atoms toward each other from the filler 718 and nickel coating 716, respectively, thereby forming a copper-nickel alloy which may be tracked by elemental mapping (e.g., SEM, EDS). In 704, nickel coating 716 extends through the filler 718 to the surface 722 of the heat exchanger shown, therefore, an alloy may have been formed between the filler 718 and nickel coating 716. In contrast, a post-braze nickel plated copper heat exchanger (e.g., the post-braze nickel plated copper heat exchanger shown in image 702) does not have an alloy formed between filler 708 and nickel coating 706 because the nickel 706 is not present under high temperatures during brazing, and consequently, no diffusional movement occurs between atoms of the filler 708 and nickel coating 706. Thus, the heating during brazing that may cause alloy formation between filler metal and nickel coatings in a pre-braze nickel plated copper heat exchanger does not cause alloy formation in a post-braze nickel plated copper heat exchanger. In other examples, alloys may be formed between nickel coatings and other filler metals. In other words, alloy formation is not limited to copper-nickel alloys formed between a copper alloy filler metal and nickel coating, as described with the example shown in FIGS. 7A and 7B. In some examples, including the example given in FIG. 7A and 7B, element tracking showing formation of an alloy from diffusional movement of atoms in a coating and a filler of a nickel plated copper heat exchanger may indicate that the nickel plated copper heat exchanger was formed by a pre-braze plating method.

Further, turning to FIGS. 10A-10D, a first graph 1010 and a second graph 1020 are respectively shown in FIG. 10A and 10B of nickel content across a post-braze plated copper heat exchanger and a pre-braze plated copper heat exchanger. A first image 1030 and a second image 1040 of cross sections of the post braze heat exchanger and the pre-braze plated copper heat exchanger are respectively shown in FIGS. 10C and 10D.

The graphs 1010, 1020 may be obtained by energy dispersive x-ray spectroscopy (EDS) analysis. A horizontal axis 1002 indicates spatial location along the sample, and a vertical axis 1004 indicates x-ray intensity corresponding to nickel content (e.g., in counts per second) emitted when the sample is bombarded with electrons. The horizontal axis 1002 spans a distance from within the copper components of the respective copper heat exchangers, through the nickel layers thereof, and to the exterior of the copper heat exchangers, as indicated by the axis 1002 overlaid on the images 1030, 1040. Regions of the graphs 1010, 1020 and the images 1030, 1040 having different compositions are delineated by dashed lines 1006 at approximate boundaries determined according to counts of photons which are characteristic of nickel and not of copper. Therefore, regions in the graphs 1010, 1020 with relatively low values along the vertical axis 1004 may comprise copper, and regions with relatively high values along the vertical axis 1004 may comprise nickel. Additional conclusions can be drawn from the graphs 1010, 1020, as described below.

The first graph 1010 and the first image 1030 include a copper region 1012, a nickel region 1014, and an exterior region 1016. The copper region 1012 comprises mostly (e.g. more than 50 wt%) copper, the nickel region 1014 comprises mostly nickel, and the exterior region 1016 comprises negligible matter due to EDS being performed under vacuum conditions. Likewise, the second graph 1020 and the second image 1040 include a copper region 1022, a nickel region 1024, an exterior region 1026, analogous to the copper region 1012, the nickel region 1014, and the exterior region 1016. As such, the copper region 1022 comprises mostly copper, the nickel region 1024 comprises mostly nickel, and the exterior region 1026 comprises negligible matter due to EDS being performed under vacuum conditions. This similarity is to be expected as both a post-braze plated copper heat exchanger and a pre-braze plated copper heat exchanger may include copper components and a nickel coating layered atop the copper.

The second graph 1020 and the second image 1040, unlike the first graph 1010 and the first image 1030, further include a nickel diffusion region 1028. The nickel diffusion region 1028 is characterized by a shallower slope in the second graph 1020 from the copper region 1022 to the nickel region 1024 compared to the copper region 1012 to the nickel region 1014. The shallower slope results from the gradual blend of copper and nickel within the nickel diffusion layer. The blend may occur due to the diffusion of nickel into the copper during brazing which follows pre-braze plating. As described above, the high heat experienced by the pre-braze plated nickel layer during subsequent brazing may lead to the nickel diffusing into the copper therebeneath. Such nickel diffusion is evinced in the graph 1020 resulting from EDS analysis of the sample shown in the image 1030, as well as the image 704 of FIG. 7B. As such, microscopy images and/or graphical data may be used to identify whether a heat exchanger was plated with nickel pre-braze or post-braze.

Turning to FIG. 8, an assembly 800 is shown. A set of reference axes 850 are shown, including an x-axis, a y-axis, and a z-axis. The z-axis may be parallel with coolant flow into and out of the heat exchanger 802 as described further below.

The assembly 800 includes a heat exchanger 802 and one or more electronic modules 804 metallurgically bonded to the heat exchanger 802. The one or more electronic modules 804 may be sensor modules, power modules, control modules, and/or the like. The electronic modules 804 may be electrically coupled to various other electronic components via couplers 820 (e.g., connector pins, terminals, etc.). The electronic modules 804 may accumulate heat during operation which may be dissipated via the heat exchanger 802. The electronic modules 804 being metallurgically bonded to the heat exchanger 802 may increase heat removal from the electronic modules 804, compared to configurations where the heat exchanger 802 and the electronic modules 804 are not metallurgically bonded. For example, the metallurgical bond may be more thermally conductive than thermal interface material (TIM).

The heat exchanger 802 may be formed by a method of pre-braze electrolytic nickel plating, such as method 100 of FIG. 1. As such, the method of forming the heat exchanger 802 may include pretreating copper; electrolytically plating the copper; stamping the copper into heat exchanger components before or after electrolytically plating the copper; and bonding (e.g., brazing) the components to form the heat exchanger 802. Thus, the heat exchanger 802 may include copper components coated in an even layer of nickel. The even layer of nickel may resemble the first nickel coating 504 with the thickness 524 being substantially the same throughout as shown in FIG. 5. Due to the plating occurring electrolytically, the nickel layer may not comprise more than a trace amount of phosphorus. The composition and thickness of the nickel layer may make the nickel layer metallurgically bondable.

In this way, by performing the method of pre-braze nickel plating to form the heat exchanger, at least one surface of the heat exchanger is metallurgically bondable. Thus, the at least one surface may be metallurgically bonded directly to another component (e.g., electronic modules 804) without use of a non-metal (e.g., organic) material, preparatory steps (e.g., application of a coating), or presence of a temporary protective layer (e.g., OSP) for preserving properties of the surface (e.g., preventing oxidation). The copper components may be substantially covered in the nickel layer. In some examples, the nickel layer may cover every surface of the copper exposed (e.g., to air) prior to plating, such that the copper components are entirely encased in the nickel layer. In other examples, some copper may be exposed, such as along edges in cases where stamping occurs following plating. The nickel layer may span both interior surfaces and exterior surfaces of the heat exchanger 802. Interior surfaces of the heat exchanger 802 may be configured to contact coolant fluid flowing through the heat exchanger via the inlet 806 and the outlet 808. Exterior surfaces of the heat exchanger 802 may be exposed to (e.g., face outward toward) the environment in which the assembly 800 is positioned (e.g., ambient air), and may not contact the coolant fluid. Thus, the copper may not be visible from any view of the heat exchanger 802, except in a cross section, in examples where the nickel layer covers every surface of the copper. Additionally, in such examples, every exposed surface (e.g., including interior surfaces and exterior surfaces) of the heat exchanger may comprise nickel. Further, in this way, every exterior surface of the heat exchanger 802 (e.g., first exterior surface 810, second exterior surface 822, etc.) may be metallurgically bondable.

The thickness of the nickel layer may be selected according to corrosion protection and metallurgical bonding abilities. The thickness may be within a first range of 0.1 µm to 10 µm for optimal metallurgical bondability. The nickel layer thickness being less than 0.1 µm may result in a weak metallurgical bond prone to premature degradation. The upper limit of the first range may be related to practicality of manufacturing rather than properties of the metallurigical bond. For example, the nickel layer thickness being greater than 10 µm may be more resource intensive and more difficult to achieve in electrolytic plating without additional benefit to the metallurgical bondability. The first range for optimal metallurgical bondability may be 0.2 µm to 2 µm, in some examples. Lowering the upper bound on the range from 10 µm to 2 µm may further decrease resource demand and allow brazability. Additionally or alternatively, the thickness may be within a second range of 0.5 µm to 5 µm for optimal corrosion protection. The nickel layer thickness being less than 0.5 µm may not be able to sufficiently protect the copper from corrosion. The nickel layer thickness being greater than 5 µm may adversely impact brazability and heat transfer capability, as well as increase resource demand. Because the first and second ranges for corrosion protection and metallurgical bondability, respectively, may overlap (e.g., between 0.5 µm and 2 µm or between 0.5 µm and 5 µm depending on the selected range for metallurgical bondability), the thickness of the nickel layer may be the same for every surface of the heat exchanger 802, including interior and exterior surfaces, in some examples. In other examples, the nickel coating may be applied in two different thicknesses according to whether the surface is interior or exterior. For example, during the method of pre-braze electrolytic nickel plating that forms the heat exchanger 802, a first portion of the copper components may be coated in a nickel coating having a first thickness in the first range, and a second portion of the copper components may be coated in a nickel coating having a second thickness in the second range. The first thickness and the second thickness may not be equal. The first portion of copper components may include one or more surfaces configured to be exterior after assembly of the heat exchanger, and the second portion of the copper components may include one or more surfaces configured to be interior after assembly of the heat exchanger, in such an example.

Three electronic modules 804 are shown for example in FIG. 8, including a first electronic module 804a, a second electronic module 804b, and a third electronic module 804c. However, more or fewer electronic modules than three may be included in other embodiments. The electronic modules 804 may be metallurgically bonded directly to the first exterior surface 810 of the heat exchanger 802. The first exterior surface 810 faces toward a first side 812 of the assembly 800 (e.g., to a positive z-direction). The first side 812 is vertically opposite a second side 814 of the assembly 800 with respect to the figure. However, the assembly 800 may be oriented otherwise in practice. For example, the sides 812, 814 may be horizontally opposite each other. The first side 812 may be opposite from the second side 814 along the z-axis.

The heat exchanger 802 may be an embodiment of the heat exchanger 600 of FIG. 6. As such, the heat exchanger 802 comprises two or more inlet/outlet tubes (e.g., inlet/outlet tubes 604 of FIG. 6) such as an inlet 806 and an outlet 808. Coolant fluid may flow into and out of the heat exchanger 802 via the inlet 806 and the outlet 808, respectively, as indicated by arrows 832. The inlet 806 may be proximate to a first end 816 of the heat exchanger 802 and the outlet 808 may be proximate to a second end 818 of the heat exchanger 802. The first end 816 and the second end 818 may be opposite across the heat exchanger 802 along the x-axis. The inlet 806 and the outlet 808 may protrude from the second exterior surface 822 facing the second side 814 (e.g., facing a negative z-direction). The inlet 806 and the outlet 808 may extend parallel with the z-axis. The first exterior surface 810, whereto the electronic modules 804 may be metallurgically bonded (e.g., soldered), may face opposite of the second exterior surface 822. In this way, the inlet 806 and the outlet 808 may be positioned opposite the electronic modules 804 across the heat exchanger 802 (e.g., along the z-axis).

Alternative configurations of the assembly 800 are possible. For example, the electronic modules 804 may be positioned on and metallurgically bonded to the same exterior surface (e.g., either the first exterior surface 810 or the second exterior surface 822) from which the inlet 806 and the outlet 808 protrude. In another example, the inlet 806 and the outlet 808 may be positioned on opposite sides of the heat exchanger 802 from each other such that one of the inlet 806 and the outlet 808 protrudes from the first exterior surface 810 and the other protrudes from the second exterior surface 822. Additionally or alternatively, in examples with more than one electronic module, the electronic modules 804 may be positioned on and metallurgically bonded to both the first exterior surface 810 and the second exterior surface 822. That is, a first portion of the electronic modules 804 may be positioned on and metallurgically bonded to the first exterior surface 810, and a second portion of the electronic modules 804 may be positioned on and metallurgically bonded to the second surface 822.

The electronic modules 804 being directly metallurgically bonded to the heat exchanger 802 (more specifically the nickel layer thereof) may allow for greater heat transfer from the electronic modules 804 than other configurations, such as TIM being interposed between the electronic modules 804 and the heat exchanger 802. Further, the metallurgical bond may be irreversible while TIM attached components may be disassembled. Therefore, the metallurgical bond may be more resistant to mechanical degradation (e.g., degradation due to movement, vibration, etc.) over time. Further still, the nickel layer (which may not include more than a trace amount of phosphorus due to being electrolytically plated onto the copper prior to brazing) may allow the metallurgical bond to be formed directly, meaning without applying an additional layer, such as OSP, to provide a metallurgically bondable surface. By eliminating such a layer, resource demand and manufacturing operations may be reduced.

Turning to FIG. 9, a method 900 is shown for manufacturing an assembly comprising a heat exchanger and one or more electronic modules. For example, the method 900 may be performed to create the assembly 800 of FIG. 8 including the heat exchanger 802 and the electronic modules 804.

At 902, method 900 includes forming the heat exchanger by a method of pre-braze electrolytic nickel plating. For example, method 100 of FIG. 1 may be performed to form the heat exchanger. As such, 902 may include pretreating copper; electrolytically plating nickel onto the copper; stamping the copper into heat exchanger components; and brazing the components together. Pretreating occurs prior to electrolytically plating. Stamping may occur before or after pretreating and/or electrolytically plating. For example, stamping may occur before pretreating, between pretreating and electrolytically plating, or after electrolytically plating. Brazing may occur only after electrolytically plating. Therefore, brazing may not occur before electrolytically plating. As a result of the method of pre-braze electrolytic nickel plating, the heat exchanger may comprise copper coated in a layer of nickel. The nickel layer may not comprise a substantial amount (e.g., more than 1 wt%) phosphorus. In at least some examples, the nickel layer may further not include substantial amounts (e.g., more than 1 wt% each) of other non-metal elements. In at least some examples, the nickel layer may be substantially pure nickel. For example, the nickel layer may comprise at least 99 wt% nickel. The nickel layer may have an approximately even thickness. The thickness may be in a range of 0.1 µm and 10 µm. The thickness being in this range may contribute to metallurgical bondability of the nickel layer. That is, a thickness outside of the range may lead to unsuccessful (e.g., weak) metallurgical bonds formed in a subsequent step of method 900. In some examples, the thickness may be in a range of 0.5 and 5 µm for increased corrosion protection. The heat exchanger formed at 902 may not include further layers in addition to the nickel layer electrolytically plated onto the copper. The heat exchanger may consist substantially of copper, nickel, and the brazing filler metal. Other materials than copper, nickel, and the brazing filler metal may be present in trace amounts (e.g., no more than 1 wt%).

Method 900 proceeds to 904. At 904, method 900 includes metallurgically bonding (e.g., soldering) an electronic component directly to an exterior surface of the heat exchanger, such as the first exterior surface 810 of FIG. 8. The exterior surface may comprise substantially pure nickel. The exterior surface may be substantially free of phosphorus, meaning there may be traces of phosphorus but no more than 1 wt%. Further, the exterior surface may not include non-metal element other than in trace amounts (e.g., no more than 1 wt% of the non-metal element). The metallurgical bond may be formed between the nickel layer comprising the exterior surface, a metallurgical bonding agent (e.g., solder), and a surface of the electronic module without any intervening layers.

Method 900 may not include steps between 902 and 904 to prepare the nickel plated copper heat exchanger formed at 902 for metallurgical bonding due to the nickel layer thereof being inherently metallurgically bondable following plating. Method 900 may proceed directly from 902 to 904. In this way, additional materials and/or steps may not be demanded between assembling the heat exchanger (e.g., brazing the nickel plated copper components) and metallurgically bonding the electronic module thereto.

Turning to FIGS. 11A-11D, a first graph 1110 and a second graph 1120 are respectively shown in FIG. 11A and 11B of graphs of nickel content of a post-braze plated copper heat exchanger and an assembly comprising a pre-braze plated copper heat exchanger. A first image 1130 and a second image 1140 of cross sections of the post braze heat exchanger and the pre-braze plated copper heat exchanger are respectively shown in FIGS. 11C and 11D.

The graphs 1110, 1120 may be obtained by EDS analysis of the samples shown in the images 1130, 1140. A horizontal axis 1102 indicates spatial location along the sample, and a vertical axis 1104 shows x-ray intensity (e.g., in counts per second) emitted when the sample is bombarded with electrons. The horizontal axis 1102 spans a distance from within the copper components of the respective copper heat exchangers, through the nickel layers thereof, and to the exterior of the copper heat exchangers, as indicated by the axis 1102 overlaid on the images 1130, 1140. Regions of the graphs 1110, 1120 and the images 1130, 1140 having different compositions are delineated by dashed lines 1106 at approximate boundaries determined according to the nickel content shown in the graphs 1110, 1120, as described above.

The first graph 1110 and the first image 1130 include a copper region 1112, a nickel region 1114, and a metallurgic bonding agent region 1116. The copper region 1112 comprises mostly (e.g. more than 50 wt%) copper, the nickel region 1114 comprises mostly nickel, and the metallurgic bonding agent region 1116 comprises a metallurgic bonding agent, such as solder or the like. Likewise, the second graph 1120 and the second image 1140 include a copper region 1122, a nickel region 1124, a metallurgic bonding agent region 1126, analogous to the copper region 1112, the nickel region 1114, and the metallurgic bonding agent region 1116. As such, the copper region 1122 comprises mostly copper, the nickel region 1124 comprises mostly nickel, and the metallurgic bonding agent region 1126 comprises metallurgic bonding agent. This similarity is to be expected as both a post-braze plated copper heat exchanger and a pre-braze plated copper heat exchanger may include copper components and a nickel coating layered atop the copper, and both copper heat exchanger types may be metallurgically bonded to another metal component.

However, a post-braze plated copper heat exchanger may not be directly metallurgically bonded to the metal component. To elaborate, the post-braze copper heat exchanger comprising nickel plated onto copper may not be configured to metallurgically bond to the metal component without additional steps and/or materials. In contrast, the pre-braze plated copper heat exchanger may be directly metallurgically bonded to the metal component. While this distinction between pre- and post-braze plated copper heat exchangers may not be visible in images and/or spectroscopy graphs in some examples, it may be determined from chemical composition. For example, a post-braze plated copper heat exchanger may comprise a nickel layer that includes phosphorus due to being plated electrolessly for reasons described above, while a pre-braze plated copper heat exchanger may comprise a nickel layer that does not include more than a trace amount of phosphorus due being electrolytically plated as described above. In such an example, the substantial amount of phosphorus may prevent the post-braze plated copper heat exchanger from being metallurgically bondable without additional steps and/or materials in preparation for metallurgic bonding. Conversely, the pre-braze nickel plated copper heat exchanger may be directly metallurgically bonded (e.g., without additional steps and/or materials), in part due to lack of phosphorus or presence of phosphorus in a trace amount.

Additionally, the second graph 1120 and the second image 1140, unlike the first graph 1110 and the first image 1130, further include a nickel diffusion region 1128 which differentiates the pre- and post-braze nickel plated copper heat exchangers. Similar to the nickel diffusion region 1028 of FIGS. 10B and 10D, the nickel diffusion region 1128 is characterized by a shallower slope in the graph 1120 from the copper region 1122 to the nickel region 1124 compared to the copper region 1112 to the nickel region 1114. As described above, the blend of copper and nickel within the nickel diffusion region 1128 may occur due to the diffusion of nickel into the copper during high heat conditions of brazing which follows pre-braze plating.

The technical effect of the systems and methods disclosed herein related to nickel plated copper assemblies, such as nickel plated copper heat exchangers, formed by pre-braze nickel plating, and without brazing prior to nickel plating, is to reduce degradation of braze joints that occurs during pretreatment in a post-braze plating process, increase efficiency of the nickel plating process, produce more even nickel plating coverage over surfaces of the copper heat exchangers, and provide surfaces which may be directly metallurgically bonded to an electronic module or other metal component without an intermediate layer such as OSP. Further, diffusion of the nickel into the copper may result in the underlying copper surface being more durable.

The disclosure also provides support for an assembly, comprising: a heat exchanger comprising at least one nickel diffusion region where nickel is diffused into copper, and an electronic module metallurgically bonded directly to an exterior surface of the heat exchanger. In a first example of the system the exterior surface is substantially pure nickel. In a second example of the system, optionally including the first example, the exterior surface does not include more than a trace amount of phosphorus. In a third example of the system, optionally including one or both of the first and second examples, a nickel layer of the heat exchanger comprising the exterior surface has a thickness of 0.1 µm to 10 µm. In a fourth example of the system, optionally including one or more or each of the first through third examples, the heat exchanger is formed by a method of pre-braze electrolytic nickel plating. In a fifth example of the system, optionally including one or more or each of the first through fourth examples, interior surfaces of the heat exchanger are coated with a nickel layer having a thickness of 0.5 µm to 5 µm. In a sixth example of the system, optionally including one or more or each of the first through fifth examples, the at least one nickel diffusion region includes a first nickel diffusion region where a first nickel coating covering a first copper component is diffused into the first copper component. In a seventh example of the system, optionally including one or more or each of the first through sixth examples, the at least one nickel diffusion region further includes a second nickel diffusion region where a second nickel coating covering a second copper component is diffused into the second copper component. In an eighth example of the system, optionally including one or more or each of the first through seventh examples, a filler is diffused into the first nickel coating.

The disclosure also provides support for a method, comprising: forming a heat exchanger by pre-braze electrolytic nickel plating, and metallurgically bonding an electronic module directly to an exterior surface of the heat exchanger. In a first example of the method, the exterior surface comprises nickel and does not include more than a trace amount of phosphorus. In a second example of the method, optionally including the first example, the method does not include applying a layer over a nickel coating of the heat exchanger deposited by the pre-braze electrolytic nickel plating to enable metallurgical bonding. In a third example of the method, optionally including one or both of the first and second examples, pre-braze electrolytic nickel plating comprises: electrolytically plating nickel onto copper, stamping the copper into heat exchanger components before or after electrolytically plating, and brazing the components to form the heat exchanger after plating and stamping. In a fourth example of the method, optionally including one or more or each of the first through third examples, electrolytically plating the nickel onto the copper results in a nickel coating having a thickness in a range of 0.1 µm to 10 µm. In a fifth example of the method, optionally including one or more or each of the first through fourth examples, brazing occurs only after plating.

The disclosure also provides support for a heat exchanger, comprising: a first copper component including a first nickel coating having a first thickness in a range of 0.1 µm to 10 µm, and a first nickel diffusion region where the first nickel coating is diffused into the copper of the first copper component, a second copper component, and a filler positioned between the first copper component and the second copper component, wherein the filler is diffused through the first nickel coating. In a first example of the system, the heat exchanger is configured to be directly metallurgically bonded to an electronic module. In a second example of the system, optionally including the first example, the second copper component includes a second nickel coating having a second thickness in a range of 0.1 µm to 10 µm, and a second nickel diffusion region where the second nickel coating is diffused into the copper of the second copper component, where the filler is further diffused through the second nickel coating. In a third example of the system, optionally including one or both of the first and second examples, the first thickness and the second thickness are approximately equal. In a fourth example of the system, optionally including one or more or each of the first through third examples, the filler is a copper-phosphorus alloy and/or copper-phosphorus-silver alloy.

In another representation, the disclosure also provides support for a method, comprising: pretreating a copper piece, electrolytically plating the copper piece with nickel to form a nickel plated copper piece, after electrolytically plating the copper piece with nickel, stamping components from the nickel plated copper piece to form stamped, nickel plated components, and brazing the stamped, nickel plated components. In a first example of the method, brazing occurs only after plating the copper piece with nickel. In a second example of the method, optionally including the first example, electrolytically plating the copper piece with nickel results in a nickel coating having a thickness in a range of 0.5 µm to 5 µm. In a third example of the method, optionally including one or both of the first and second examples, brazing includes applying a filler metal, and wherein the filler metal diffuses into at least one nickel coating, forming an alloy of the filler metal and the at least one nickel coating. In a fourth example of the method, optionally including one or more or each of the first through third examples, brazing forms a heat exchanger. In a fifth example of the method, optionally including one or more or each of the first through fourth examples, brazing is not completed before plating.

In another representation, the disclosure also provides support for a method, comprising: electrolytically plating a copper or copper alloy piece with nickel or nickel alloy to form a nickel or nickel alloy plated copper or copper alloy piece, wherein electrolytic plating occurs before or after stamping the copper or copper alloy piece, brazing the nickel or nickel alloy plated copper or copper alloy piece, wherein brazing forms a heat exchanger. In a first example of the method, the copper or copper alloy piece is pretreated prior to electrolytically plating. In a second example of the method, optionally including the first example, stamping occurs after electrolytically plating and prior to brazing. In a third example of the method, optionally including one or both of the first and second examples, electrolytically plating results in a nickel coating having a thickness in a range of 0.5 µm to 5 µm. In a fourth example of the method, optionally including one or more or each of the first through third examples, brazing includes applying a filler metal, and wherein the filler metal diffuses into at least one nickel or nickel alloy coating, forming an alloy of the filler metal and the at least one nickel or nickel alloy coating. In a fifth example of the method, optionally including one or more or each of the first through fourth examples, the method further comprises: uncoiling the copper or copper alloy piece before plating. In a sixth example of the method, optionally including one or more or each of the first through fifth examples, brazing occurs only after plating. In a seventh example of the method, optionally including one or more or each of the first through sixth examples, brazing is not completed prior to plating.

In another representation, the disclosure also provides support for a heat exchanger, comprising: a first copper component including a first nickel coating having a thickness in a range of 0.5 µm to 5 µm, a second copper component including a second nickel coating having a thickness in a range of 0.5 µm to 5 µm, a filler positioned between the first copper component and the second copper component, wherein the filler is diffused through the first nickel coating and the second nickel coating. In a first example of the system, the filler is a copper-phosphorus alloy or copper-phosphorus-silver alloy. In a second example of the system, optionally including the first example, the heat exchanger is formed by a method of pre-braze nickel plating. In a third example of the system, optionally including one or both of the first and second examples, the first copper component and the second copper component are stamped from nickel or nickel alloy plated copper or copper alloy. In a fourth example of the system, optionally including one or more or each of the first through third examples, an alloy is formed by the filler and one or more of the first nickel coating and the second nickel coating. In a fifth example of the system, optionally including one or more or each of the first through fourth examples, the first nickel coating is in face-sharing contact with the first copper component and the second nickel coating is in face-sharing contact with the second copper component.

In another representation, a method of forming a heat exchanger may comprise: pretreating a copper blank, electrolytically plating the copper blank with nickel to form a nickel plated copper blank, after electrolytically plating the copper blank with nickel, stamping components from the nickel plated copper blank to form stamped, nickel plated components, and brazing the stamped, nickel plated components to form a brazed assembly. In a first example of the method, brazing occurs only after plating the copper blank with nickel. In a second example of the method, optionally including the first example, electrolytically plating the copper blank with nickel results in a nickel coating having a thickness in a range of 0.5 µm to 5 µm. In a third example of the method, optionally including one or both of the first and second examples, brazing includes applying a filler metal, and wherein the filler metal diffuses into at least one nickel coating, forming an alloy of the filler metal and nickel coatings. In a fourth example of the method, optionally including one or more or each of the first through third examples, the method further comprises: forming a heat exchanger with the brazed, stamped, nickel plated components. In a fifth example of the method, optionally including one or more or each of the first through fourth examples, brazing is not completed before plating.

In another representation, a method of forming a heat exchanger may comprise: uncoiling a copper coil to form an uncoiled copper coil, electrolytically plating the uncoiled copper coil with nickel, and brazing components of the nickel plated copper coil. In a first example of the method, the copper coil is pretreated prior to electrolytically plating. In a second example of the method, optionally including the first example, the method further comprises: stamping the nickel plated copper coil, following electrolytically plating and prior to brazing. In a third example of the method, optionally including one or both of the first and second examples, electrolytically plating the copper coil with nickel results in a nickel coating having a thickness in a range of 0.5 µm to 5 µm. In a fourth example of the method, optionally including one or more or each of the first through third examples, brazing includes applying a filler metal, and wherein the filler metal diffuses into at least one nickel coating, forming an alloy of the filler metal and nickel coatings. In a fifth example of the method, optionally including one or more or each of the first through fourth examples, brazing forms a heat exchanger. In a sixth example of the method, optionally including one or more or each of the first through fifth examples, brazing occurs only after plating. In a seventh example of the method, optionally including one or more or each of the first through sixth examples, brazing is not completed prior to plating. In an eighth example of the method, optionally including one or more of each of the first through seventh examples, the method further comprises: re-coiling the uncoiled, nickel plated copper coil following electrolytically plating.

In another representation, a heat exchanger may comprise: a first copper component including a first nickel coating having a thickness in a range of 0.5 µm to 5 µm, a second copper component including a second nickel coating having a thickness in a range of 0.5 µm to 5 µm, a filler positioned between the first copper component and the second copper component, wherein the filler is diffused through the first nickel coating and the second nickel coating. In a first example of the system, the filler is a copper-phosphorus alloy or copper-phosphorus-silver alloy. In a second example of the system, optionally including the first example, the heat exchanger is formed by a method of pre-braze nickel plating. In a third example of the system, optionally including one or both of the first and second examples, the first copper component and the second copper component are stamped from nickel plated copper. In a fourth example of the system, optionally including one or more or each of the first through third examples, an alloy is formed by the filler and one or more of the first nickel coating and the second nickel coating. In a fifth example of the system, optionally including one or more or each of the first through fourth examples, the first nickel coating is in face-sharing contact with the first copper component and the second nickel coating is in face-sharing contact with the second copper component.

In another representation, a method of forming a heat exchanger may comprise: pretreating one or more unformed copper pieces; electrolytically plating nickel onto the one or more copper pieces at a thickness in a range of 0.5 µm to 5 µm; stamping a first component of a heat exchanger and a second component of a heat exchanger from the one or more nickel coated copper; and brazing the first component of the heat exchanger to the second component of the heat exchanger.

FIGS. 5, 6, and 8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An assembly, comprising:
a heat exchanger comprising at least one nickel diffusion region where nickel is diffused into copper; and
an electronic module metallurgically bonded directly to an exterior surface of the heat exchanger.

2. The assembly of claim 1, the exterior surface is substantially pure nickel.

3. The assembly of claim 1, wherein the exterior surface does not include more than a trace amount of phosphorus.

4. The assembly of claim 1, wherein a nickel layer of the heat exchanger comprising the exterior surface has a thickness of 0.1 µm to 10 µm.

5. The assembly of claim 1, wherein the heat exchanger is formed by a method of pre-braze electrolytic nickel plating.

6. The assembly of claim 1, wherein interior surfaces of the heat exchanger are coated with a nickel layer having a thickness of 0.5 µm to 5 µm.

7. The assembly of claim 1, wherein the at least one nickel diffusion region includes a first nickel diffusion region where a first nickel coating covering a first copper component is diffused into the first copper component.

8. The assembly of claim 7, wherein the at least one nickel diffusion region further includes a second nickel diffusion region where a second nickel coating covering a second copper component is diffused into the second copper component.

9. The assembly of claim 7, wherein a filler is diffused into the first nickel coating.

10. A method, comprising:
forming a heat exchanger by pre-braze electrolytic nickel plating; and
metallurgically bonding an electronic module directly to an exterior surface of the heat exchanger.

11. The method of claim 10, wherein the exterior surface comprises nickel and does not include more than a trace amount of phosphorus.

12. The method of claim 10, wherein the method does not include applying a layer over a nickel coating of the heat exchanger deposited by the pre-braze electrolytic nickel plating to enable metallurgical bonding.

13. The method of claim 10, wherein pre-braze electrolytic nickel plating comprises:
electrolytically plating nickel onto copper;
stamping the copper into heat exchanger components before or after electrolytically plating; and
brazing the components to form the heat exchanger after plating and stamping.

14. The method of claim 13, wherein electrolytically plating the nickel onto the copper results in a nickel coating having a thickness in a range of 0.1 µm to 10 µm.

15. The method of claim 13, wherein brazing occurs only after plating.

16. A heat exchanger, comprising:
a first copper component including a first nickel coating having a first thickness in a range of 0.1 µm to 10 µm, and a first nickel diffusion region where the first nickel coating is diffused into the copper of the first copper component;
a second copper component; and
a filler positioned between the first copper component and the second copper component, wherein the filler is diffused through the first nickel coating.

17. The heat exchanger of claim 16, wherein the heat exchanger is configured to be directly metallurgically bonded to an electronic module.

18. The heat exchanger of claim 16, wherein the second copper component includes a second nickel coating having a second thickness in a range of 0.1 µm to 10 µm, and a second nickel diffusion region where the second nickel coating is diffused into the copper of the second copper component, where the filler is further diffused through the second nickel coating.

19. The heat exchanger of claim 18, wherein the first thickness and the second thickness are approximately equal.

20. The heat exchanger of claim 16, wherein the filler is a copper-phosphorus alloy and/or copper-phosphorus-silver alloy.
